(19) United States
(12) Patent Application Publication
(10) Pub. No.: US 2019/0370491 A1
(43) Pub. Date: Dec. 5, 2019

(54) METHOD FOR LOCAL PROFILING OF A USER OF A TERMINAL AND METHOD FOR SEARCHING FOR PRIVATE INFORMATION

(71) Applicant: QWANT, Paris (FR)

(72) Inventor: Eric LEANDRI, paris (FR)

(21) Appl. No.: 16/472,878

(22) PCT Filed: Dec. 22, 2017
(86) PCT No.: PCT/EP2017/084523

§ 371 Date: Jun. 23, 2019

(30) Foreign Application Priority Data
Dec. 22, 2016 (FR) 1663251
Dec. 22, 2016 (FR) 1663265

(51) Int. Cl. G06F 21/62; G06F 16/2457; G06F 16/248; H04W 12/06

(52) U.S. Cl. CPC G06F 21/6245; H04W 12/06; G06F 16/248; G06F 16/24578

(57) ABSTRACT

The method (100) for local profiling of a user of a terminal comprises, iteratively:—a step (105) of unlocking, by the user, the access to a local user profile of the user,—a step (110) of detecting processing of events, by the user on this terminal and—a step (115) of editing the user profile as a function of each detected processing.

### TECHNICAL FIELD OF THE INVENTION

The present invention relates to a method for local profiling of a user of a terminal. It applies, in particular, to searching resources on an internet type of network combined with searching the private resources of a user.

### STATE OF THE ART

In the field of searching computer resources on the internet, online search engines, accessible via an internet browser, are now implemented.

These search engines base the results provided, in response to a request, on an indexation of the content and a profiling of the user.

The drawback of the current search engines is that they intrude into users' private lives, especially through the profiling action which boils down to monitoring the users' actions and the association of behaviors or the detection of associated interests.

For this reason, these search engines are limited to searches of computer resources on the internet.

Other internal, private search modules, built into the operating systems, make it possible to access the computer content of the terminal associated to the operating system.

Therefore, there is currently no search system making it possible to aggregate public internet search results and private search results without entry into the user's private life to determine the relevance of the results.

### SUBJECT OF THE INVENTION

The present invention aims to remedy all or part of these drawbacks.

To this end, according to a first aspect, the present invention envisages a method for local profiling of a user of a terminal. which comprises, iteratively:
a step of unlocking, by the user, access to a local user profile of the user;
a step of detecting a treatment of events by the user on said terminal; and
a step of editing the user profile as a function of each treatment detected.

Thanks to these provisions, the user chooses, as a function of the unlocking or not, whether a profiling of his actions is performed. This profiling enables the enrichment of methods for searching for private information in particular.

According to a second aspect, the present invention envisages a method for searching for private information, which comprises:
a profiling method that is the subject of the present invention;
a step of entering search keywords by the user on the terminal;
a step of searching for private information as a function of entered keywords;
a step of ranking said private information as a function of the local user profile; and
a step of displaying the ranked private information, the editing step editing the user profile as a function of the processing performed on at least one item of private information displayed.

Thanks to these provisions, the relevance of the private information displayed is enhanced by means of the profiling of the user.

In some embodiments, the method that is the subject of the present invention comprises a step of creating an index of personal information, the unlocking step unlocking access to the index for the search step.

These embodiments make it possible to optimize the speed of the search for private information.

In some embodiments, the index is stored in a remote memory resource, the unlocking step unlocking access to this resource.

These embodiments allow access to the index to be restricted to the user.

In some embodiments, the index is synchronized on the portable terminal when access to the index is unlocked.

These embodiments make it possible for any terminal associated with a user to have access to a common index synchronized and shared between the terminals.

In some embodiments, the method that is the subject of the present invention comprises:
a step of sending a request to a remote server for results of a search for public information; and
a step of receiving public information, the display step displaying the private and public information, said information being identified as such.

These embodiments allow public and private information to be presented to the user on a single interface, each type of information having been acquired by a separate search mechanism allowing the user's privacy to be preserved.

In some embodiments, the method that is the subject of the present invention comprises a step of associating remote personal information storage services, the information of each associated service being implemented during the step of detecting the treatment of events.

These embodiments make it possible to search for private information within a personal cloud.

In some embodiments, the unlocking step is performed remotely from the terminal.

These embodiments allow the unlocking step to be made secure and this step to be shared with each terminal associated with the user.

In some embodiments, the unlocking step comprises a step of authenticating the portable terminal on a cellular telephone network.

These embodiments utilize a well-known network and a third-party unlocking mechanism with regard to an internet network.

In some embodiments, the unlocking step utilizes a virtual SIM card.

The present invention also envisages a method for providing information, comprising a step of a user entering keywords, via a man-machine interface, into an internet browser, which method comprises:
a step of sending a request to a remote server for public search results, based on the entered keywords;
a step of unlocking access to private information by the user;
a step of searching for private information, access to which is unlocked, based on the entered keywords, providing private search results;
a step of receiving public search results from the remote server; and
a step of displaying the public search results received and the private search results on a single interface, the private and public results being identified as such on this interface.

Thanks to these provisions, the user chooses, as a function of the unlocking or not, whether the search module is given access to the private resources. Neither the access to the private data, nor the search module require communication over a remote data network to operate. In addition, the search for public data and the search for private data do not utilize the same search engine, the public data search engine having no access to the content of the private data search. Lastly, no profiling of the user, based on the private data, is performed to assist the public data search.

In some embodiments, the method that is the subject of the present invention comprises a step of associating remote private information storage services, the information of each associated service being implemented during the step of searching for private information.

These embodiments make it possible to search for private information within a personal cloud.

In some embodiments, the method that is the subject of the present invention comprises a step of creating an index of private information, the unlocking step unlocking access to the index for the search step.

These embodiments make it possible to optimize the speed of the search for private information.

In some embodiments, the index is stored in a remote memory resource, access to which is unlocked during the unlocking step.

These embodiments allow access to the index to be restricted to the user.

In some embodiments, the index is synchronized on the portable terminal when access to the remote memory is unlocked.

These embodiments make it possible for any terminal associated with a user to have access to a common index synchronized and shared between the terminals.

In some embodiments, the private results and public results are respectively displayed in columns in a single page.

These embodiments provide clear identification and fluid reading of the search results by type of result.

In some embodiments, the unlocking step is implemented remotely from the terminal.

These embodiments allow the unlocking step to be made secure and this step to be shared with each terminal associated with the user.

In some embodiments, the unlocking step comprises a step of authenticating the portable terminal on a cellular telephone network.

These embodiments implement a well-known network and a third-party unlocking mechanism with regard to an internet network.

In some embodiments, the unlocking step implements a virtual SIM card.

### BRIEF DESCRIPTION OF THE FIGURES

Other advantages, aims and particular features of the invention will become apparent from the non-limiting description that follows of at least one particular embodiment of the device and method that are the subjects of the present invention, with reference to drawings included in an appendix, wherein:

FIG. 1 represents, schematically and in the form of a logical diagram, a particular series of steps of a first embodiment of the method that is the subject of the present invention;

FIG. 2 represents, schematically and in the form of a logical diagram, a particular series of steps of a second embodiment of the method that is the subject of the present invention;

FIG. 3 represents, schematically, a particular embodiment of an interface for presenting search results of the method that is the subject of the present invention;

FIG. 4 represents, schematically, a particular embodiment of a device utilizing the method that is the subject of the present invention;

FIG. 5 represents, schematically and in the form of a logical diagram, a particular series of steps of the method that is the subject of the present invention;

FIG. 6 represents, schematically, a particular embodiment of an interface for presenting search results of the method that is the subject of the present invention; and

FIG. 7 represents, schematically, a particular embodiment of a device utilizing the method that is the subject of the present invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

The term “information” refers to digital data that can take the form of text, image, sound, video or executable files or internet pages. This term is synonymous with “computer resources”. This term also means any address of digital data such as the data mentioned above.

The term “Internet” refers to the World Wide Web internet network.

The term “internet browser” refers to software designed for browsing and displaying the World Wide Web, having at least one area for entering search keywords and an interface for displaying search results.

The term “terminal” refers to an electronic device comprising a man-machine interface, a means for communicating with the internet network, and a display screen, this terminal being configured to run the internet browser. As an illustration, a terminal can be:
a smartphone;
a digital tablet; or
a personal computer.

The term “event” refers to any interaction, via a human interface, of the user with the terminal that has an effect on at least one execution parameter of a software system of the terminal. Such an interaction can be:
entering search keywords, in an internet browser for example;
viewing a file;
running a file.

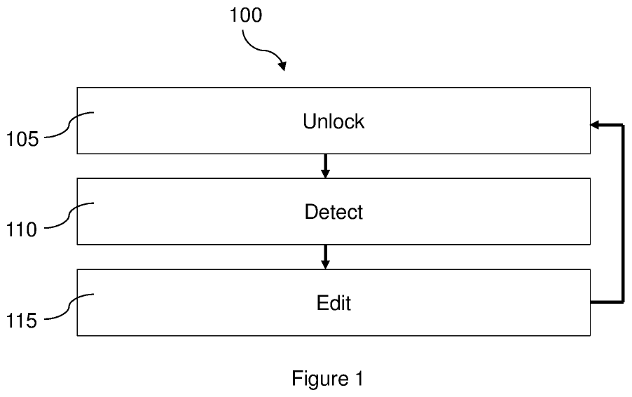

FIG. 1 shows a schematic view of a logical diagram of particular steps for realizing the method 100 that is the subject of the present invention. This method 100 for local profiling of a user of a terminal comprises, iteratively:
a step 105 of unlocking, by the user, access to a local user profile of the user;
a step 110 of detecting the treatment of events by the user on this terminal; and
a step 115 of editing the user profile as a function of each treatment detected.

This unlocking step 105 implements any type of mechanism for unlocking access to known computer content. Such a mechanism is, for example, the comparison of a code entered by the user, via the man-machine interface of the terminal, with a code previously saved on the terminal or remote from this terminal. In other variants, the mechanism is a biometric identification mechanism using fingerprint or ocular recognition.

In particular, this unlocking step 105 can be performed by a plug-in module of a browser installed by the user or pre-installed on the browser. This plug-in module also makes it possible to perform the search step 210.

In some variants, the unlocking step 105 is implemented remotely from the terminal.

In some particular embodiments, such as that shown in FIG. 1, the unlocking step 105 comprises a step 245 of authenticating the portable terminal on a cellular telephone network.

This authentication step 245 is performed, for example, by authenticating a SIM card associated with the terminal on a cellular telephone network.

In some variants, the unlocking step 105 implements a virtual SIM card.

A virtual SIM card is a rewritable dedicated memory space in the terminal, whose content is transmitted by a radio channel, this content comprising the identification data of the terminal on a cellular telephone network.

The step 110 of detecting the treatment of events is performed, for example, by utilizing an electronic control circuit associated to a software system configured to detect actions performed by a user on the terminal. These actions, associated to an event, can be dated.

The editing step 115 is performed, for example, by an electronic calculation circuit associated to a software system, this software system being configured to determine a user profile as a function of treatments performed on events. This profile relates, for example, to the user's preferences, statically or over time, to the correlation between a series of events, such as successive searches, or to a frequency of occurrence of identified events.

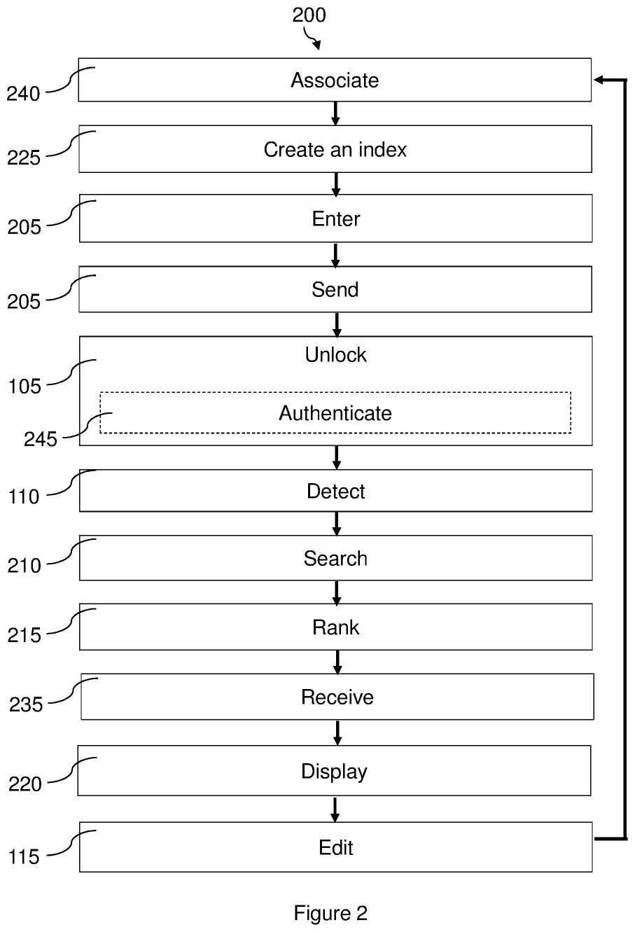

FIG. 2 shows, schematically, a logical diagram of particular steps of the method 200 that is the subject of the present invention. This method 200 for searching for private information comprises:
a profiling method 100 as described with regard to FIG. 1;
a step 205 of entering, by the user, search keywords on the terminal;
a step 210 of searching for private information as a function of entered keywords;
a step 215 of ranking private information as a function of the local user profile; and
a step 220 of displaying the ranked private information, the editing step 115 editing the user profile as a function of the processing performed on at least one item of private information displayed.

The entry step 205 is performed by any type of man-machine interface known to the person skilled in the art. Such an interface is, for example, a mechanical keyboard, virtual keyboard, touch keyboard, mouse or voice command interface.

The man-machine interface employed depends on the terminal running the internet browser.

By means of this man-machine interface, the user fills in entered keywords in a search field of the internet browser. These keywords correspond to the search objects desired by the user.

The step 210 of searching for private information implements an electronic calculation circuit associated to software for searching private computer resources. The term “private computer resources”, “private resources” or “private data” refers to:
the computer data present in the terminal's memory; and
the computer data of any computer service of cloud computing type requiring a form of identification in order to access them.

This private information comprises, for example, emails, text, image or video files, internet pages or application launcher executables.

During this search step 210, the software identifies private information corresponding to keywords based on data in this information or metadata, filters these results and puts the remaining results into order.

Preferably, the search step 210 is performed locally, at the terminal, by the plug-in module installed in the browser. In this way, the handling of private information is not remote from the terminal, which is not likely to compromise the user's privacy.

The ranking step 215 is performed, for example, by an electronic calculation circuit associated to a software system configured to rank each item of information identified during the search step 210 as a function of the profile.

This ranking is performed as a function of the content of each item of information, or associated metadata, and parameter values of the user's profile. For example, a user having searched on several occasions for the word “Italy” and then searched for “Photos” will see first of all personal photos associated to the value “Italy” in the memory.

In some preferred embodiments, as shown in FIG. 1, the method 200 comprises a step 225 of creating an index of private information, the unlocking step 115 unlocking access to the index for the search step.

This creation step 225 is implemented by an electronic calculation circuit of the terminal or by a remote server associated with the terminal. During this creation step 225, all of the private information available is identified, then each item of information is categorized, based on data in the content or on metadata of this content, and then the information is grouped together based on similarity of category.

In some variants, the index is stored in a remote memory resource, access to which is unlocked during the unlocking step 105.

In some variants, the index is synchronized on the portable terminal when access to the remote memory is unlocked 105.

The synchronization implemented corresponds to a synchronization, well known to the person skilled in the art, of computer files between several receiving terminals for these files.

The display step 220 is performed, for example, by utilizing an electronic control circuit of a screen of the terminal so as to display, in the browser, the private and public information, or a link to this information, on this screen.

The specification of the information is achieved by separating the information into two columns on the browser interface: a first column for the public information and a second column for the private information.

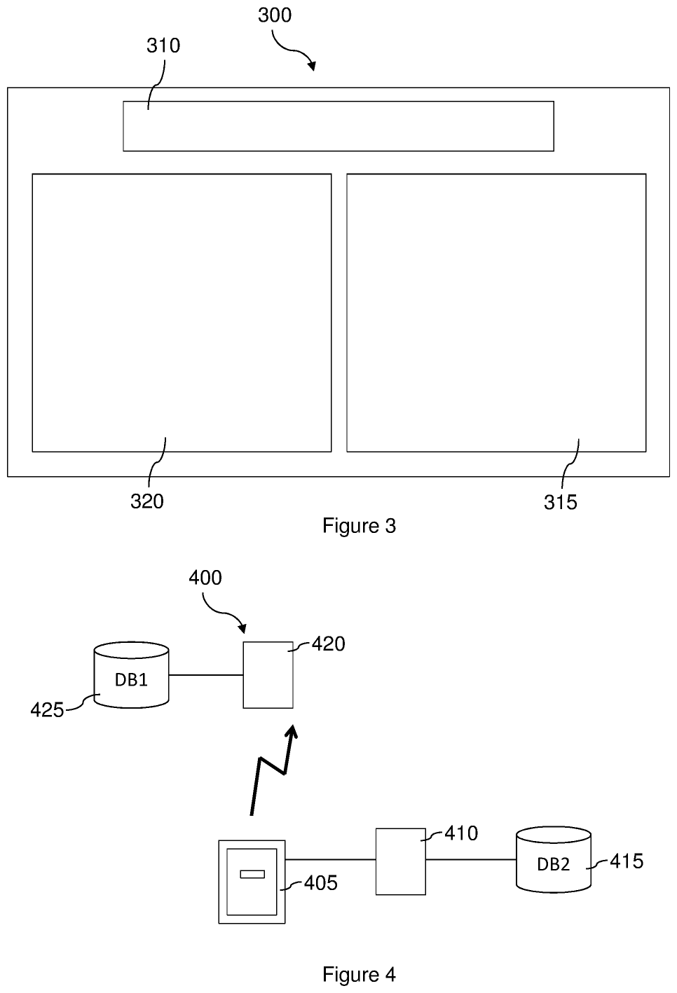

An example of such an interface can be seen in FIG. 3. This interface 100 comprises:
an entry field 310 for entering search keywords;
a column 315 of private information coming from the search step 210; and
a column 320 of public information coming from the reception step 235.

In some particular embodiments, such as that shown in FIG. 1, the method 200 comprises:
a step 230 of sending a request to a remote server for results of a search for public information; and
a step 235 of receiving public information, the display step 220 displaying the private and public information, this information being identified as such.

The sending step 230 implements an electronic control circuit of the communication means of the terminal. This communication means is, for example, an antenna configured to emit and receive wireless telecommunications signals, or a physical network port configured to receive a cable connecting the terminal to the internet network.

During this sending step 230, a request comprising the keywords is sent to the remote server.

The remote server is a search engine for searching public computer resources on the internet. Preferably, this search engine does not comprise a user-profile associated to the terminal.

The step 125 of receiving public results is performed by the communication means of the terminal, for example.

In some particular embodiments, the method 200 comprises a step 240 of associating remote personal information storage services, the information of each associated service being implemented during the step of detecting the treatment of events.

This association step 240 is performed, for example, by the user entering on the terminal:
an identity of the service to be associated; and
identifiers enabling the connection to this service on behalf of the user.

This association step 240 implements the establishment of a computer communication between the terminal and each service associated in this way by means of identifiers entered and recorded.

Once this association has been created, the associated service's data forms part of the data considered during the search step 210.

Such an association can be removed by the user.

FIG. 4 shows, schematically, a system 400 able to implement the method 100 or 200 that is the subject of the present invention.

This system 400 comprises:
a terminal 405;
a search engine 420 remote from the terminal, and a database 425 associated with this search engine;
a software system 410 for searching for private information, and a database 415 associated with this software system.

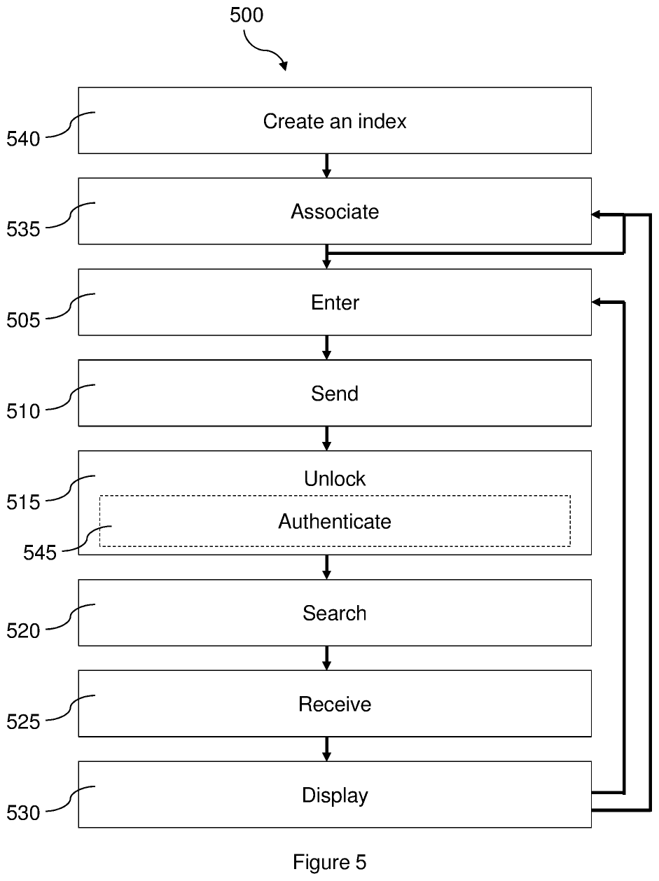

FIG. 5 shows a schematic view of a logical diagram of particular steps for realizing the method 500 that is the subject of the present invention. This method 500 for providing information, comprising a step 505 of a user entering keywords, via a man-machine interface, into an internet browser, comprises:
a step 510 of sending a request to a remote server for public search results, based on the entered keywords;
a step 515 of unlocking, by the user, access to private information;
a step 520 of searching for private information, access to which is unlocked, based on the entered keywords, providing private search results;
a step 525 of receiving public search results from the remote server; and
a step 530 of displaying the public search results received and the private search results on a single interface, the private and public results being identified as such on this interface.

The entry step 505 is performed by any type of man-machine interface known to the person skilled in the art. Such an interface is, for example, a mechanical keyboard, virtual keyboard, touch keyboard, mouse or voice command interface.

The man-machine interface employed depends on the terminal running the internet browser.

By means of this man-machine interface, the user fills in entered keywords in a search field of the internet browser. These keywords correspond to the search objects desired by the user.

The sending step 510 implements an electronic control circuit of the communication means of the terminal. This communication means is, for example, an antenna configured to emit and receive wireless telecommunications signals, or a physical network port configured to receive a cable connecting the terminal to the internet network.

During this sending step 510, a request comprising the keywords is sent to the remote server.

The remote server is a search engine for searching public computer resources on the internet. Preferably, this search engine does not comprise a user-profile associated to the terminal.

In parallel with or consecutive to this sending step 510, the method 500 implements the unlocking step 515. This unlocking step 515 implements any type of mechanism for unlocking access to known computer content. Such a mechanism is, for example, the comparison of a code entered by the user, via the man-machine interface of the terminal, with a code previously saved on the terminal or remote from this terminal. In other variants, the mechanism is a biometric identification mechanism using fingerprint or ocular recognition.

In particular, this unlocking step 515 can be performed by a plug-in module of the browser installed by the user or pre-installed on the browser. This plug-in module also makes it possible to perform the search step 520.

In some variants, the unlocking step 515 is implemented remotely from the terminal.

In some particular embodiments, such as that shown in FIG. 5, the unlocking step 515 comprises a step 545 of authenticating the portable terminal on a cellular telephone network.

This authentication step 545 is performed, for example, by authenticating a SIM card associated with the terminal on a cellular telephone network.

In some variants, the unlocking step 515 implements a virtual SIM card.

A virtual SIM card is a rewritable dedicated memory space in the terminal, whose content is transmitted by a radio channel, this content comprising the identification data of the terminal on a cellular telephone network.

In some preferred embodiments, such as that shown in FIG. 5, the method 500 comprises a step 535 of associating remote private information storage services, the information of each associated service being implemented during the step 520 of searching for private information.

This association step 535 is performed, for example, by the user entering on the terminal:
an identity of the service to be associated; and
identifiers enabling the connection to this service on behalf of the user.

This association step 535 implements the establishment of a computer communication between the terminal and each service associated in this way by means of identifiers entered and recorded.

Once this association has been created, the associated service's data forms part of the data considered during the search step 520.

Such an association can be removed by the user.

The step 520 of searching for private information implements an electronic calculation circuit associated to software for searching private computer resources.

During this search step 520, the software identifies private information corresponding to keywords based on data in this information or metadata, filters these results and puts the remaining results into order.

Preferably, the search step 520 is performed locally, at the terminal, by the plug-in module installed in the browser. In this way, the handling of private information is not remote from the terminal, which is not likely to compromise the user's privacy.

In some preferred embodiments, as shown in FIG. 5, the method 500 comprises a step 540 of creating an index of private information, the unlocking step 515 unlocking access to the index for the search step.

This creation step 540 is implemented by an electronic calculation circuit of the terminal or by a remote server associated with the terminal. During this creation step 540, all of the private information available is identified, then each item of information is categorized, based on data in the content or on metadata of this content, and then the information is grouped together based on similarity of category.

In some variants, the index is stored in a remote memory resource, access to which is unlocked during the unlocking step 515.

In some variants, the index is synchronized on the portable terminal when access to the remote memory is unlocked 515.

The synchronization implemented corresponds to a synchronization, well known to the person skilled in the art, of computer files between several receiving terminals for these files.

The step 525 of receiving public results is performed by the communication means of the terminal, for example.

The display step 530 is performed, for example, by utilizing an electronic control circuit of a screen of the terminal so as to display, in the browser, the private and public information, or a link to this information, on this screen.

The specification of the information is achieved by separating the information into two columns on the browser interface: a first column for the public information and a second column for the private information.

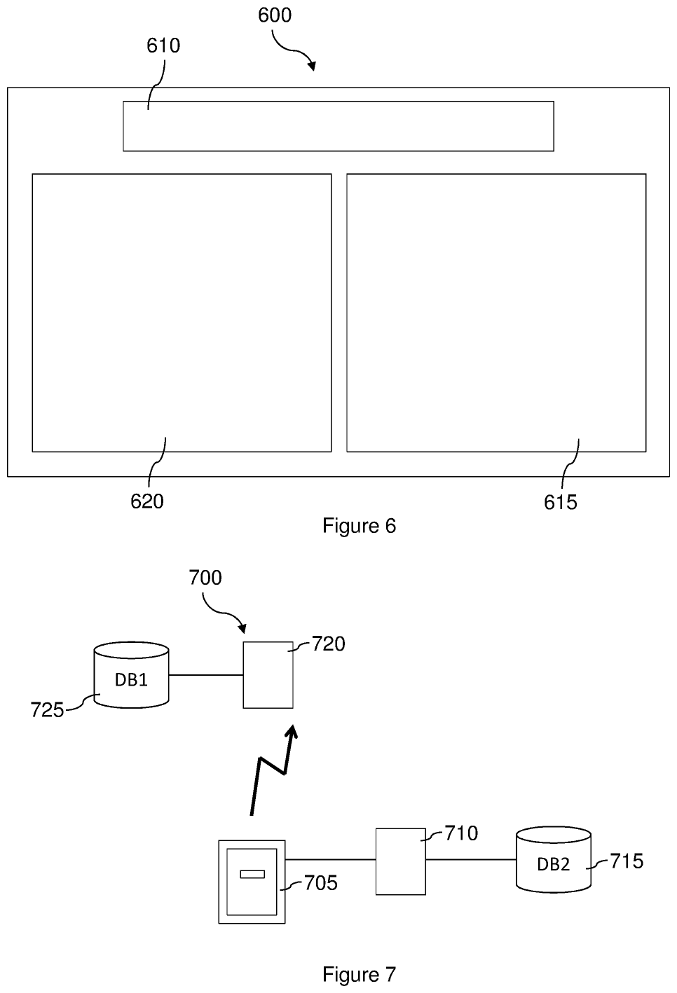

An example of such an interface can be seen in FIG. 6. This interface 600 comprises:
an entry field 610 for entering search keywords;
a column 615 of private information coming from the search step 620; and
a column 620 of public information coming from the reception step 625.

FIG. 7 shows, schematically, a system 700 able to implement the method 500 that is the subject of the present invention.

This system 700 comprises:
a terminal 705;
a search engine 720 remote from the terminal, and a database 725 associated with this search engine;
a software system 710 for searching for private information, and a database 715 associated with this software system.

In this way, as can be understood, the method 100 that is the subject of the present invention implements two independent search mechanisms. The first, searching for public information, requires no specific precaution to protect the user's privacy so long as profiling of this user is not performed. The second, handling private data, is unlocked intentionally by the user only when a search of this private data has to be performed.

1. A method for local profiling of a user of a terminal, comprising, iteratively:
a step of unlocking, by the user, access to a local user profile of the user;
a step of detecting a treatment of events by the user on said terminal; and
a step of editing the user profile as a function of each treatment detected.

2. A method for searching for private information, comprising: a profiling method according to claim 1;
a step of entering search keywords by the user on the terminal;
a step of searching for private information as a function of entered keywords;
a step of ranking said private information as a function of the local user profile; and
a step of displaying the ranked private information, during the editing step, editing the user profile as a function of the processing performed on at least one item of private information displayed.

3. A method according to claim 2, which comprises a step of creating an index of private information, the unlocking step unlocking access to the index for the search step.

4. A method according to claim 3, wherein the index is stored in a remote memory resource, the unlocking step unlocking access to this resource.

5. A method according to claim 4, wherein the index is synchronized on the portable terminal when access to the index is unlocked.

6. A method according to claim 3, which comprises:
a step of sending a request to a remote server for results of a search for public information; and
a step of receiving public information,
the display step displaying the private and public information, said information being identified as such.

7. A method according to claim 2, which comprises a step of associating remote private information storage services, the information of each associated service being implemented during the step of detecting the treatment of events.

8. A method according to claim 1, wherein the unlocking step is performed remotely from the terminal, the unlocking step comprising a step of authenticating the portable terminal on a cellular telephone network.

9. A method according to claim 8, wherein the unlocking step implements a virtual SIM card.

10. A method according to claim 1, which comprises:
a step of sending a request to a remote server for public search results, based on the entered keywords;
a step of unlocking access to private information by the user;
a step of searching for private information, access to which is unlocked, based on the entered keywords, providing private search results;
a step of receiving public search results from the remote server; and
a step of displaying the public search results received and the private search results on a single interface, the private and public results being identified as such on this interface.

11. A method according to claim 10, which comprises a step of associating remote private information storage services, the information of each associated service being implemented during the step of searching for private information.

12. A method according to claim 10, which comprises a step of creating an index of private information, the unlocking step unlocking access to the index for the search step.

13. A method according to claim 12, wherein the index is stored in a remote memory resource, access to which is unlocked during the unlocking step.

14. A method according to claim 13, wherein the index is synchronized on the portable terminal when access to the remote memory is unlocked.

15. A method according to claim 10, wherein the unlocking step is implemented remotely from the terminal, the unlocking step comprises a step of authenticating the portable terminal on a cellular telephone network.

16. A method according to claim 15, wherein the unlocking step implements a virtual SIM card.
